(19) United States
(12) Patent Application Publication
(10) Pub. No.: US 2011/0169323 A1
(43) Pub. Date: Jul. 14, 2011

(54) Vehicle Launch Startup Clutch Protection on a Grade

(75) Inventors: Hongtei E. Tseng, Canton, MI (US); Michael G. Fodor, Dearborn, MI (US); Christopher J. Teslak, Plymouth, MI (US); Bradley D. Riedle, Northville, MI (US); Eileen A. Davidson, Dexter, MI (US)

(73) Assignee: FORD GLOBAL TECHNOLOGIES, LLC, Dearborn, MI (US)

(21) Appl. No.: 12/686,486

(22) Filed: Jan. 13, 2010

(51) Int. Cl. B60T 8/32; B60T 7/06

(52) U.S. Cl. 303/191; 477/195

(57) ABSTRACT

A method for controlling a vehicle powertrain includes holding the vehicle stopped on a grade by automatically producing wheel brake torque while driver demand torque is less than wheel brake torque, automatically releasing wheel brake torque when driver demand torque equals or exceeds wheel brake torque, and launching the vehicle using engine torque.

### BACKGROUND OF THE INVENTION

1. Field of the Invention

This invention relates generally to controlling the powertrain of a motor vehicle while launching the vehicle on a grade.

2. Description of the Prior Art

A vehicle that is stopped on a grade can be held stationary using wheel brake torque until propulsion torque, transmitted from the engine through a transmission and final drive mechanism to the wheels, exceeds brake torque. It is important to avoid unnecessary transmission clutch slip when brake torque is holding the hill, particularly when the transmission lacks a torque converter.

An electronic signal representing estimated propulsion torque can be used as a measure of propulsion torque at the wheels to release brake torque. In this case, either a brief timeout occurs after neither the brake pedal nor accelerator pedal is depressed by the driver, or the brakes are applied indefinitely if the driver depresses the accelerator pedal greater than a small amount. In the latter case, the resulting propulsion torque is smaller than brake torque.

The period during which propulsion torque is less than brake torque can be significant especially in heavy traffic on a grade, and would cause excessive, unnecessary clutch wear.

### SUMMARY OF THE INVENTION

A method for controlling a vehicle powertrain includes establishing first and second functions relating desired engine torque and driver demand torque corresponding to hill start assist being active and inactive, respectively; while hill start assist is active, holding the vehicle stopped on a grade by automatically producing wheel brake torque and producing engine torque derived from the first function; automatically releasing wheel brake torque when driver demand torque equals or exceeds wheel brake torque; launching the vehicle using engine torque derived from the first function and corresponding to said pedal displacement; and while hill start assist is inactive, launching the vehicle using engine torque derived from the second function.

The method reduces clutch wear by lower engine torque levels when the driver is pressing the accelerator pedal to a level insufficient to launch the vehicle on the current grade.

The scope of applicability of the preferred embodiment will become apparent from the following detailed description, claims and drawings. It should be understood, that the description and specific examples, although indicating preferred embodiments of the invention, are given by way of illustration only. Various changes and modifications to the described embodiments and examples will become apparent to those skilled in the art.

### DESCRIPTION OF THE DRAWINGS

The invention will be more readily understood by reference to the following description, taken with the accompanying drawings, in which:

FIG. 1 is a schematic diagram of a vehicle powertrain;

FIG. 2 schematic diagram of a multiple speed, hydraulically actuated automatic transmission;

FIG. 3 is a logic flow diagram of a control algorithm; and

FIG. 4 is a graph showing functions used to determine a desired engine torque when hill start assist is active and inactive.

### DESCRIPTION OF THE PREFERRED EMBODIMENT

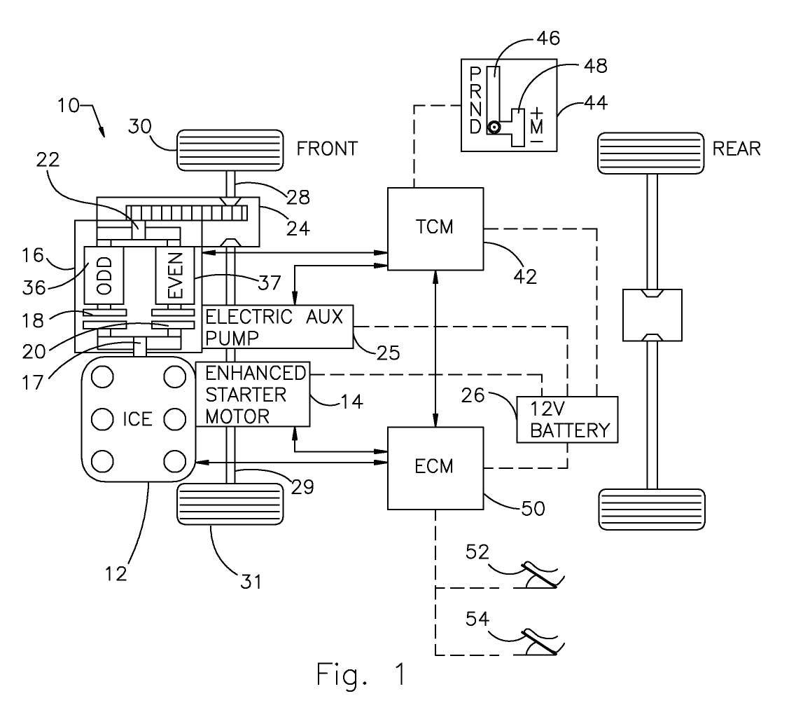

Referring now to the drawings, there is illustrated in FIG. 1 a motor vehicle powertrain 10, which includes a power source 12, such as an internal combustion engine; an engine starter motor 14; a dual clutch automatic transmission 16, connected to the engine by an input shaft 17 and clutches 18, 20; an electro-mechanical actuator 25, which varies the torque transmitting capacity of the clutches; a first layshaft 36 containing odd gears first, third, fifth and reverse gears; a second layshaft 37 containing even gears second, fourth, and sixth gears; a transmission output 22; final drive mechanism 24, connected to the output 22; an electric storage battery 26, which supplies electric power to the starter motor14 and clutch actuator 25; and axle shafts 28, 29, driveably connect to the driven wheels 30, 31.

A vehicle controller comprising a transmission module (TCM) 42 and an engine control module ECM 50 communicates through electronic signals mutually and with battery 26, transmission 16, the clutch actuator 25, and a gear selector 44, which moves among (P)ARK, (R)REVERSE, (N)EUTRAL, and (D)RIVE positions in an automatic mode channel 46 and between upshift (+) and downshift (−) positions in a manual mode channel 48. The engine control module (ECM) 50 is powered by battery 26, receives and sends signals to the starter 14 and engine 12 and receives input signals from an accelerator pedal 52 and brake pedal 54.

FIG. 1 shows the transmission 16 in the form of a powershift automatic transmission, in which the dual clutches 18, 20 produce a drive connection between the transmission's input 17 and layshafts 36, 37.

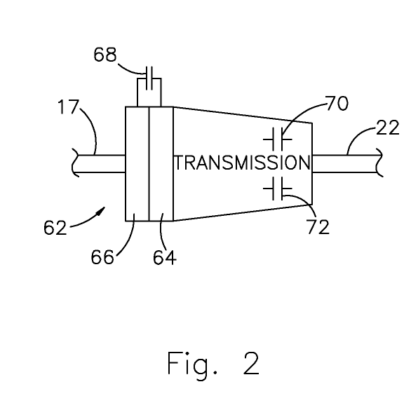

FIG. 2 illustrates an alternative in which the transmission is a multiple-speed, hydraulically actuated automatic transmission 60 having a torque converter 62, which includes an impeller 64, connected to the engine 12; a turbine 66, hydrokinetically driven by the impeller; and a bypass clutch 68, which alternately driveably connects the turbine to the impeller and releases that connection. Located within transmission 60 are friction control elements 70, 72, i.e., clutches and brakes, whose state of coordinated engagement and disengagement produce forward drive and reverse drive.

The accelerator pedal 52 and brake pedal 54 are controlled manually by depressing the respective pedal through a distance from a reference state, in which the pedal is not depressed. The accelerator pedal 52 provides input demand, i.e., drive demand torque, to the vehicle controller for changes in engine torque. Engine torque, transmitted through the transmission 16, 60 and final drive mechanism 24 to the wheels, powers the driven wheels 30, 31 with wheel torque. The accelerator pedal 54 provides demands to the vehicle controller for changes in wheel brake torque. Under certain conditions, the controller can actuate the brake system automatically to produce wheel brake torque that holds the vehicle stationary on a grade without actuating the brake pedal 54.

The vehicle controller, a microprocessor-based controller accessible to a control algorithm 76, communicates through electronic signals transmitted on a communication bus with the engine 12, starter 14, transmission 16, 60, gear selector 40, accelerator and brake pedals 52, 54, and a wheel brake system, which supplies brake pressure to the wheel brakes to produce the wheel brake torque that holds the vehicle stationary on a grade. The controller is accessible to data stored in electronic memory relating engine torque and accelerator pedal displacement, which indicated the magnitude of driver demand torque.

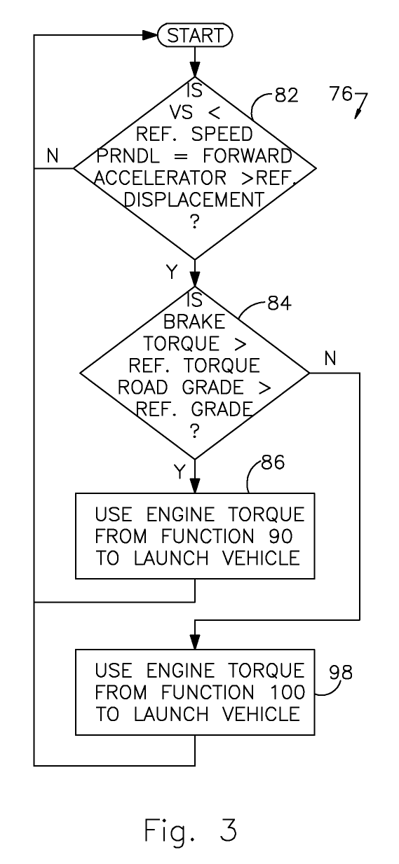

As illustrated in FIG. 3, at step 82 of control algorithm 76 a test is made to determine whether vehicle speed (VS) is less than a reference speed, the gear selector 40 is in a forward drive position, and accelerator pedal 52 is displaced greater than a reference displacement, indicating that vehicle launch control is active. If the result of test 82 is logically false, control returns to 82.

If the result of test 82 is true, control advances to 84 where a test is made to determine whether the road grade is greater than a reference road grade, and whether brake torque is greater than a reference brake torque that will hold the vehicle stationary on the grade, indicating that hill start assist (HSA) control is active. When hill start assist (HSA) control is active, the vehicle controller actuates the brake system to produce wheel brake torque automatically at a wheel torque magnitude that holds the vehicle stationary on the road grade.

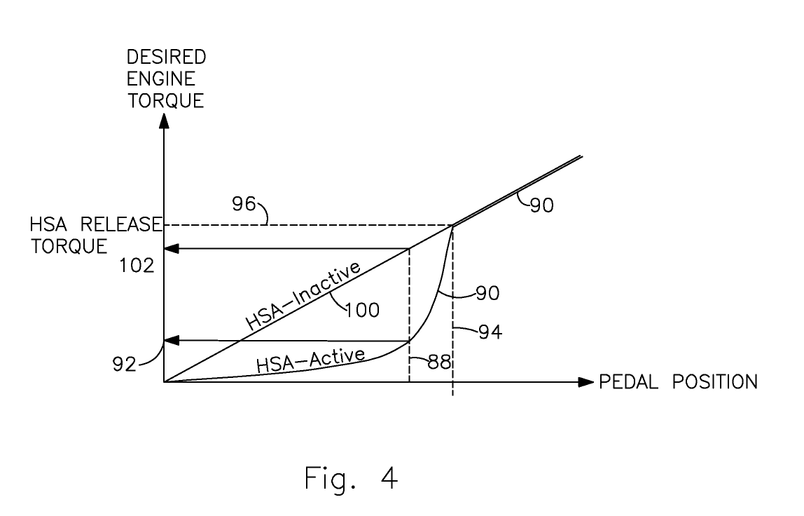

If the result of test 84 is logically true, control advances to step 86 where, as illustrated in FIG. 4, current accelerator pedal displacement 88 is used to index a function 90 relating engine torque and accelerator pedal displacement, i.e., driver demand torque, to determine the desired engine output torque 92 while HSA is active. Function 90 may be a family of curves corresponding to the magnitude of the road grade, such that desired engine output torque 92 increases as road grade increases.

If current accelerator pedal displacement 88 is greater than 94, where hill-start-assist brake release torque 96 is less than the engine torque that will produce wheel torque equal to the brake release torque, then brake torque is released and the vehicle is launched using engine torque alone.

If the result of test 84 is false, indicating that hill start assist (HSA) control is inactive, control advances to step 98 where current accelerator pedal displacement 88 is used to index a function 100 to determine the desired engine output torque 102 while HSA is inactive.

When the transmission includes at dual input clutches 18, 20 such as the powershift transmission 16 of FIG. 1, the torque transmitted by the active input clutch follows engine torque indirectly, thereby avoiding need for the controller to directly control clutch torque capacity.

In accordance with the provisions of the patent statutes, the preferred embodiment has been described. However, it should be noted that the alternate embodiments can be practiced otherwise than as specifically illustrated and described.

The invention claimed is:

1. A method for controlling a vehicle powertrain comprising:
(a) holding the vehicle stopped on a grade by automatically producing wheel brake torque while driver demand torque is less than wheel brake torque;
(b) automatically releasing wheel brake torque when driver demand torque equals or exceeds wheel brake torque; and
(c) launching the vehicle using wheel torque.

2. The method of claim 1 further comprising:
determining that vehicle speed is less than a reference speed, an accelerator pedal is depressed by at least a reference distance, and a gear selector is in a forward drive position, before executing step (a).

3. The method of claim 1 wherein step (a) further comprises:
determining that the grade is equal to or greater than a reference grade; and
producing pressure in wheel brakes of the vehicle at a magnitude equal to or greater than a reference pressure.

4. The method of claim 1 wherein step (a) further comprises:
automatically producing wheel brake torque equal to or greater than a first reference wheel brake torque.

5. The method of claim 1 wherein step (b) further comprises:
automatically releasing wheel brake torque when engine torque equals or exceeds a wheel brake torque that holds the vehicle stationary on a road grade.

6. A method for controlling a vehicle powertrain comprising:
(a) establishing first and second functions relating desired engine torque and driver demand torque corresponding to hill start assist being active and inactive, respectively;
(b) while hill start assist is active, holding the vehicle stopped on a grade by automatically producing wheel brake torque and producing engine torque derived from the first function;
(c) automatically releasing wheel brake torque when driver demand torque equals or exceeds wheel brake torque;
(d) launching the vehicle using engine torque derived from the first function and corresponding to said pedal displacement.
(e) while hill start assist is inactive, launching the vehicle using engine torque derived from the second function.

7. The method of claim 6 wherein step (a) accelerator pedal displacement indicates the magnitude of driver demand torque in the first and second functions.

8. The method of claim 6 further comprising:
determining that vehicle speed is less than a reference speed, an accelerator pedal is depressed by at least a reference distance, and a gear selector is in a forward drive position, before executing step (b).

9. The method of claim 6 wherein step (b) further comprises:
determining that the grade is equal to or greater than a reference grade; and
producing pressure in wheel brakes of the vehicle at a magnitude equal to or greater than a reference pressure.

10. The method of claim 6 wherein step (b) further comprises:
automatically producing wheel brake torque equal to or greater than a first reference wheel brake torque.

11. The method of claim 1 wherein step (c) further comprises:
automatically releasing wheel brake torque when engine torque equals or exceeds a wheel brake torque that holds the vehicle stationary on a road grade.
